(19) United States
(12) Patent Application Publication
(10) Pub. No.: US 2007/0070804 A1
(43) Pub. Date: Mar. 29, 2007

(54) Transmission adjusting balance device for a dental molding powder mixing machine

(76) Inventor: Shu-Lung Wang, Taipei Hsien (TW)

Correspondence Address: BIRCH STEWART KOLASCH & BIRCH, PO BOX 747, FALLS CHURCH, VA, 22040-0747, US

(21) Appl. No.: 11/235,074

(22) Filed: Sep. 27, 2005

(51) Int. Cl. B01F 9/22

(52) U.S. Cl. 366/217

(57) ABSTRACT

The invention discloses a transmission adjusting balance device for a dental molding powder mixing machine, and the transmission adjusting device includes a pulley that can be displaced for changing a belt of the pulley easily and gives a tuning effect to avoid the belt from being elastically exhausted or affecting the mixing performance. The invention also includes a level means for maintaining a balance on both sides of the mixing machine and keeping the performance of the mixing machine to achieve a balanced transmission effect.

### FIELD OF THE INVENTION

The present invention relates to a transmission adjusting device, and more particularly to a transmission adjusting balance device for a dental molding powder mixing machine.

### BACKGROUND OF THE INVENTION

In the process of making a denture, it is necessary to make a mold according to a patient's teeth, and then produce the denture according to the mold. Molding powder or gypsum is usually used as a material for making the mold, and water is added to this material and mixed evenly by hands until a sticky paste is formed. Since the foregoing paste will be solidified within a certain period of time, therefore there is not much time for users to mix the water with the material, and thus the molding material cannot be mixed evenly. Furthermore, mixing the water with the molding material by hands is laborious and there are air bubbles remained in the material, and thus causing air holes or a rough surface of the mold and adversely affecting the quality of the denture.

In view of the manual method of mixing the dental molding material, a prior art dental molding powder mixing machine has been disclosed for solving the aforementioned problems. The prior art mixing machine comprises a transmission device for rotating a containing groove and a containing cup axially connected to a V-shape frame when the motor in the mixing machine is started, so as to achieve the purpose of mixing the molding material. It is worth to note that common transmission device is engaged by a planet gear (as disclosed in the R.O.C. Patent Publication No. 274741 entitled “Printing molding material mixing machine”) or several pulleys are wound by a belt to achieve the mixing purpose.

However, the foregoing transmission device having a belt to work together with the pulleys may easily have an exhausted elasticity of the belt after the mixing machine has been used for a while. To maintain a normal function of the mixing machine, it is necessary to change the belt after a certain period of time, but the size of the belt varies according to the specifications of the transmission device, and the V-shape frame and the pulleys are fixed devices, and thus the belt should have the elastic property. If it is necessary to change the belt, the action of the belt has to be overcome, and thus making the installation or removal of the belt difficult.

If the weight of the content in the containing cup is not balanced by the weight of the corresponding frame on the other side, then the overall mixing operation will be affected and the whole system will be unstable when the mixing machine is operated.

On the other hand, the mixing machine is a precision instrument. If the belt is elastically exhausted, the balance and performance of the whole transmission device will be affected. The operating stability of the motor and the components of the motor will be affected, and thus lowering the performance of the mixing machine. Therefore, it is necessary to change the belt to maintain the performance of the mixing machine, and it causes inconvenience for users to frequently change the belt and maintain the stability of the transmission device.

### SUMMARY OF THE INVENTION

The primary objective of the present invention is to overcome the foregoing shortcomings and avoid the existing deficiencies by providing a transmission adjusting balance device for a dental molding powder mixing machine that uses a frame and a pulley of the dental molding powder mixing machine to avoid poor mixing performance due to an exhausted elasticity of the belt, and a balance instrument is installed onto the frame to achieve the transmission balance effect.

### BRIEF DESCRIPTION OF THE DRAWINGS

FIG. 1 is a schematic view of the appearance of the invention;

FIG. 2 is a bottom view of the invention;

FIG. 3 is an exploded view of a part of the invention; and

FIGS. 4A and 4B are schematic views of the movements of the invention.

### DETAILED DESCRIPTION OF THE PREFERRED EMBODIMENTS

The technical contents of the present invention will now be described in more detail hereinafter with reference to the accompanying drawings that show various embodiments of the invention.

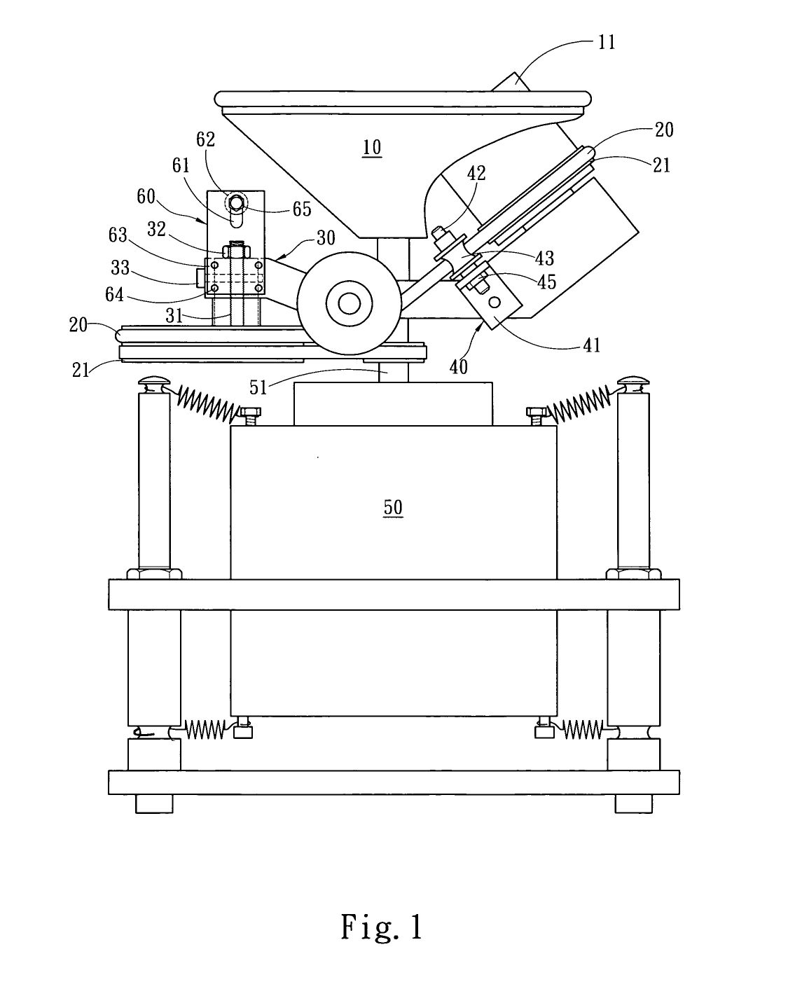

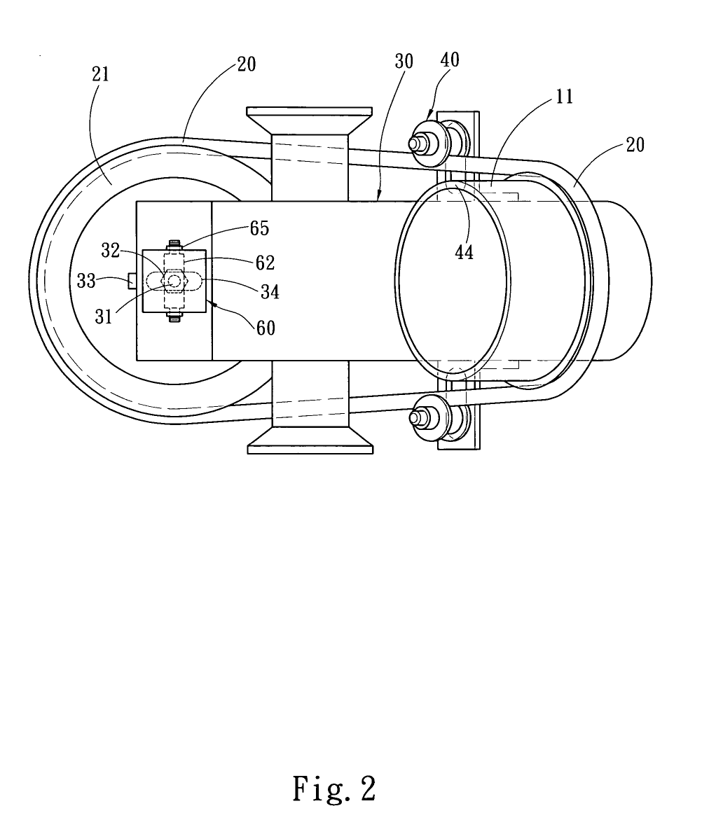

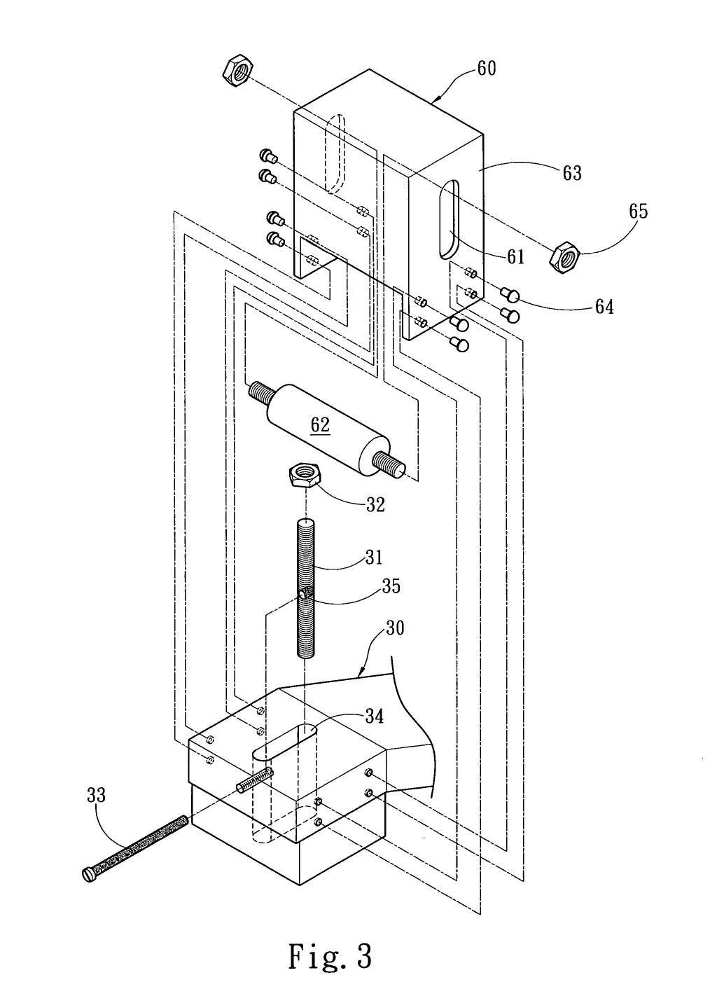

Referring to FIGS. 1 and 2 for the schematic view and the bottom view of the present invention respectively, the present invention comprises a plurality of belts 20 installed onto a plurality of corresponding pulleys 21, and the pulleys 21 is axially connected to a frame 30. Referring to FIG. 3 for the schematic view of a part of the invention, a screw rod 31 is installed on the pulley 21 corresponding to the pulley 21 of the frame 30, and the screw rod 31 has a through hole 35 for securing a screw lock 33, and the frame 30 includes a bar groove 34 for passing the screw rod 31, and the bar groove 34 is provided for installing said screw rod 31, and at least one screw nut 32 is used to fix the screw rod 31 onto different positions in the bar groove 34, and the frame 30 includes a containing groove 10 and a containing cup 11 disposed in the containing groove 10, and the belt 20 is wound around the containing cup 11, and the frame 30 is axially connected to an axle 51 of a motor 50. The foregoing frame 30 builds a level means 60 thereon, and two fixing sections 63 are extended from the level means 60, and the fixing sections 63 use at least one screw 64 to fix the fixing sections 63 onto both sides of the frame 30. Further, two bar grooves 61 are disposed on both sides of the level means 60, and a plurality of screw nuts 65 are used to fix a cylindrical steelyard weight of the level means 60 into the two grooves 61 on both sides of the level means 60. The two bar grooves 61 on both sides of the level means 60 can be used to tune the height of the cylindrical steelyard weight in the bar grooves 61. The foregoing two bar grooves 61 disposed on both sides of level means 60 could be aslant bar grooves 61 (not shown in the figure), such that when the mixing machine is operated, the centrifugal force of the adjusting balance device maintains the gravitational equilibrium of the system.

The foregoing belt 20 installs at least one pressing device 40, and the pressing device 40 comprises a pressing wheel 43, an axial rod 42, and a carrying plate 41. The carrying plate 41 is installed on the frame 30, and the axial rod 42 is installed on the carrying plate 41, and the pressing wheel 43 is axially connected onto the axial rod 42 for continuously pressing the belt 20 to prevent the belt 20 from being separated from the pulley 21 under a high-speed rotation. The carrying plate 41 is an L-shape plate and includes a sliding groove 44, and the axial rod 42 is fixed into the sliding groove 44 of the carrying plate 41 by a screw nut 45.

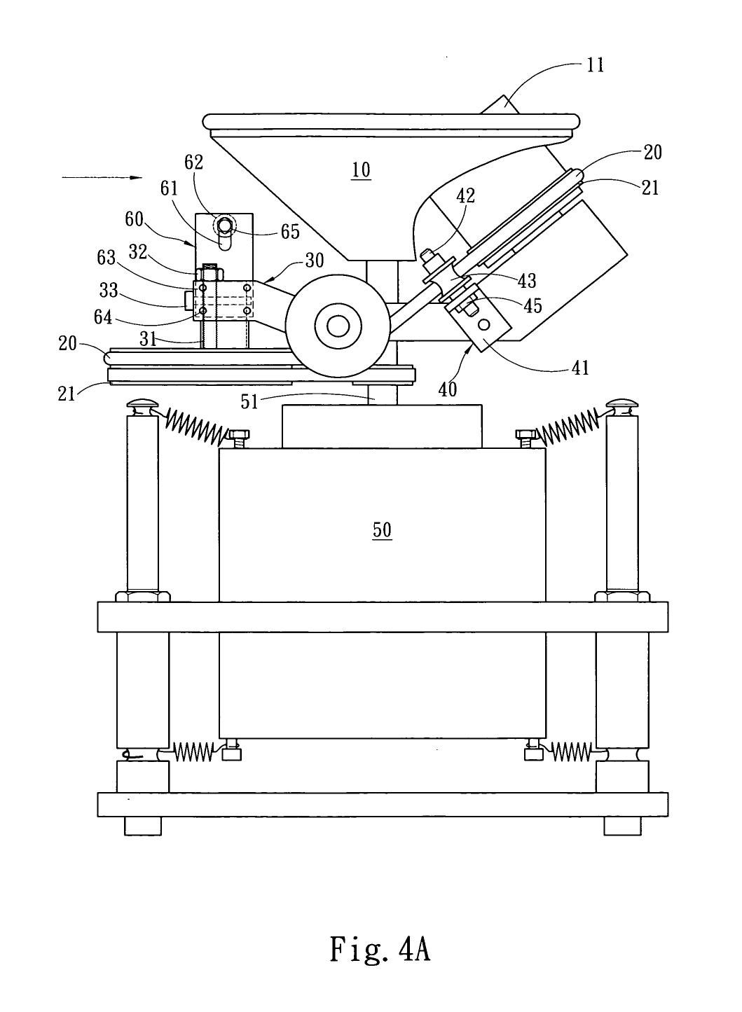

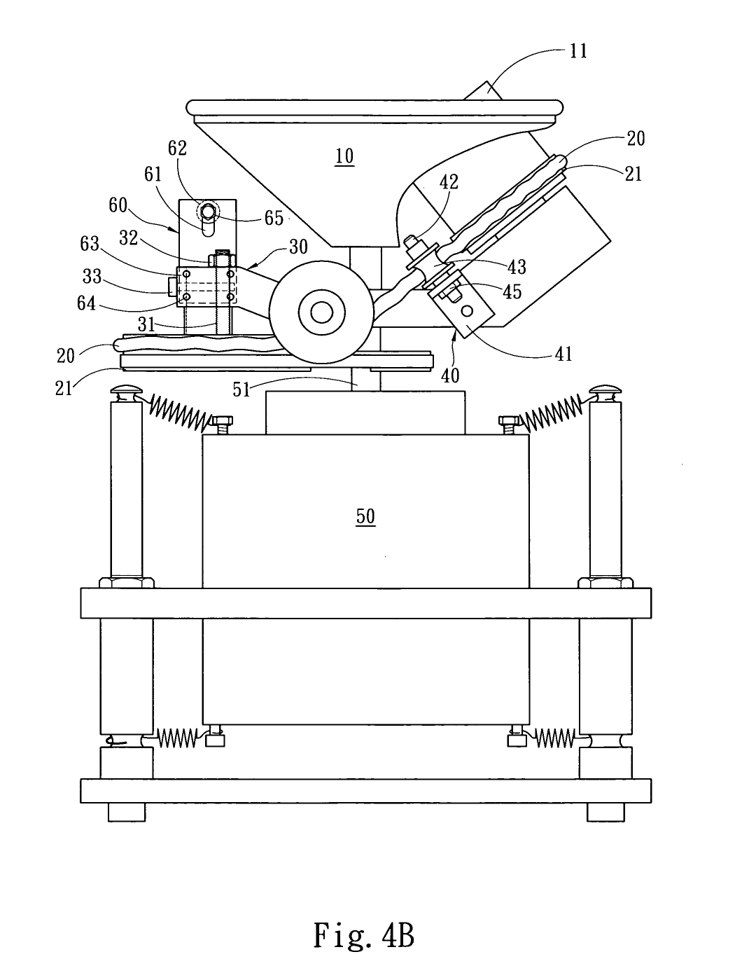

Referring to FIGS. 4A and 4B for the movements of the device of the present invention, the device is driven by a motor 50, and the axle 51 of the motor 50 drives the frame 30 to rotate. By the link of the belt 20 and the pulley 21, the containing groove 10 and the containing cup 11 on the frame 30 will rotate in opposite directions, but the belt 20 is made of an elastic material, and thus will be elastically exhausted easily under the high-speed rotation. By the screw rod 31 corresponding to the pulley 21 of the frame 30, the screw nuts 32 are loosened from the screw rod 31 first, and then the screw lock 33 is horizontally screwed in/out of the through hole 35 of the screw rod 31, such that the screw rod 31 can be moved in an opposite direction, and the screw rod 31 displaces according to the bar groove 34 of the frame 30. By the link of the screw rod 31 and the pulley 21, the screw rod 31 can be moved towards the center of the transmission device to reduce the tension of the belt 20 and facilitate changing the belt 20. If the screw rod 31 moves in the direction away from the center of the transmission device, then the tension of the belt 20 is increased to provide the required elasticity of the belt 20.

In summation of the above description, the displacement of the screw rod 31 changes the tightness of the belt 20 to achieve the transmission balance effect and facilitates the change of the belt 20 directly from the pulley 21. The pressing device 40 can be used to adjust the position of the pressing wheel 43, so as to adjust the pressing force of the pressing wheel 43 onto the belt 20 and tune the transmission adjusting device.

While the invention has been described by means of specific embodiments, numerous modifications and variations could be made thereto by those skilled in the art without departing from the scope and spirit of the invention set forth in the claims.

What is claimed is:

1. A transmission adjusting balance device for a dental molding powder mixing machine, comprising a plurality of belts and a plurality of pulleys corresponding to said belts, and a motor for rotating said belts and said pulleys by the rotation of a containing groove and a containing cup axially disposed on a frame of said motor, and said belt comprising at least one pressing device, characterized in that said pulley corresponding to said frame comprises a screw rod having a through hole for receiving a screw lock, said frame includes a bar grove for passing said screw rod, said screw rod is fixed onto said frame by at least one screw nut, and said frame installs a level means and fixes a cylindrical steelyard weight into two bar grooves disposed on both sides of said level means by a plurality of screw nuts.

2. The transmission adjusting balance device for a dental molding powder mixing machine of claim 1, wherein said pressing device comprises a carrying plate installed on said frame, and an axial rod installed on said carrying plate, and said carrying plate includes a sliding groove for passing through said axial rod, and a pressing wheel is axially coupled onto said axial rod for continuously pressing said belts.

3. The transmission adjusting balance device for a dental molding powder mixing machine of claim 1, wherein said screw rod is said screw lock penetrating into said pulley corresponding to said frame and fixed onto said pulley by at least one screw nut.
